(19) United States
(12) Patent Application Publication
(10) Pub. No.: US 2017/0030194 A1
(43) Pub. Date: Feb. 2, 2017

(54) RECIPROCATING ENGINE

(71) Applicant: Shepherd Inventor Limited, Auckland (NZ)

(72) Inventor: Graydon Aubrey Shepherd, Auckland (NZ)

(73) Assignee: Shepherd Inventor Limited, Auckland (NZ)

(21) Appl. No.: 15/303,655

(22) PCT Filed: Apr. 16, 2015
(86) PCT No.: PCT/NZ2015/000029

§ 371 Date: Oct. 12, 2016

(30) Foreign Application Priority Data
Apr. 16, 2014 (NZ) 623935
Dec. 3, 2014 (NZ) 702580

(51) Int. Cl. F01B 3/04; F01B 7/02; F02B 75/00

(52) U.S. Cl. CPC F01B 3/045; F02B 75/002; F01B 7/02; F16H 25/12

(57) ABSTRACT

A reciprocating engine having a fixed body and at least one rotating and reciprocating member. The engine also has at least one combustion chamber, and the or each combustion chamber is defined between at least a fixed member connected to the fixed body and at least one rotating and reciprocating member. The or each rotating and reciprocating member is coupled to the fixed body in such a manner that reciprocating motion of the or each rotating and reciprocating member produces rotation of the or each rotating and reciprocating member. The or each rotating and reciprocating member is coupled to an output shaft in such a manner that the rotational motion only of the or each rotating and reciprocating member is transferred to the output shaft.

### FIELD OF THE INVENTION

This invention relates to a reciprocating engine, and in particular, but not exclusively to a crankshaft-less reciprocating engine for use in vehicles and power generation.

### BACKGROUND

Many vehicles and other machines use reciprocating engines. A key feature of any engine is its efficiency.

The use of a crankshaft limits the efficiency of many engines. When the reciprocating piston is near top dead centre, or near bottom dead centre, the crank of the crankshaft is at an angle that limits the turning force or torque that can be applied by the piston to the crank shaft.

Also, many engines are only efficient when operating at high speed. And since many applications require rotary motion at a lower speed, reduction gearing is required. The use of the reduction gearing causes additional power losses.

The high pressures in modern engines contribute to the production of nitrous oxide emissions which are harmful to the environment. The high pressures and temperatures produce additional stresses on the engine components, as well as increasing the operating noise levels.

The design of combustion chambers and the dynamics within the chambers is also a key factor in the overall efficiency of an engine. Many engines have poor fuel air mixing and combustion characteristics.

The breathing efficiency of engines is also a key factor in efficiency. Four stroke engines for example use an entire rotation of the crank shaft to simply purge and recharge each cylinder. Conventional two strokes overcome this problem but experience difficulty in completely purging exhaust gases from the combustion cylinders.

### OBJECT

It is therefore an object of the present invention to provide a reciprocating engine which will at least go some way towards overcoming one or more of the above mentioned problems, or at least provide the public with a useful choice.

### STATEMENTS OF THE INVENTION

Accordingly, in a first aspect, the invention may broadly be said to consist in a reciprocating engine having a fixed body and at least one rotating and reciprocating member, the reciprocating engine also having at least one combustion chamber, and the or each combustion chamber is defined between at least a fixed member connected to the fixed body and at least one rotating and reciprocating member, and the or each rotating and reciprocating member is coupled to the fixed body in such a manner that reciprocating motion of the or each rotating and reciprocating member produces rotation of the or each rotating and reciprocating member, and the or each rotating and reciprocating member is coupled to an output shaft in such a manner that the rotational motion only of the or each rotating and reciprocating member is transferred to the output shaft.

Preferably the or each rotating and reciprocating member is concentric with the output shaft.

Preferably the or each fixed member is concentric with the or each rotating and reciprocating member.

Preferably the or each fixed member is in the form of a fixed piston member.

Preferably the or each rotating and reciprocating member includes at least one outer cylinder configured to engage with and reciprocate about a fixed member.

Preferably the or each combustion chamber is an annular shaped combustion chamber.

Preferably the or each annular shaped combustion chamber is defined between a fixed member, an outer cylinder of at least one rotating and reciprocating member, and an inner cylinder of the rotating and reciprocating member.

Preferably the or each rotating and reciprocating member is coupled to the fixed body via one or more cylindrical end cams which are mated with one or more cam engagement rollers.

Preferably the or each cam engagement roller is supported by the fixed body of the reciprocating engine.

Preferably the or each cylindrical end cam is a part of the or each rotating and reciprocating member.

Preferably the or each rotating and reciprocating member is coupled to the output shaft via a splined joint.

Preferably the or each splined joint includes a male spline profile on the output shaft and a female spline profile on the associated rotating and reciprocating member.

Preferably the or each fixed member includes provisions to mount fuel injectors and/or fuel igniters.

Preferably the reciprocating engine also includes one or more pre-charge chambers, and each pre-charge chamber communicates with at least one combustion chamber.

Preferably the reciprocating engine also includes one or more pumping chambers, and each pumping chamber communicates with at least one pre-charge chamber.

Preferably the or each rotating and reciprocating member includes a plunger which provides the pumping action within the or each pumping chamber.

Preferably the or each pumping chamber is an annular chamber situated about the or each fixed member.

Preferably the or each pre-charge chamber is an annular chamber situated within the or each fixed member.

Preferably the passage of air from the or each pumping chamber to the or each pre-charge chamber is controlled by a pre-charge inlet valve.

Preferably the or each pre-charge inlet valve is a pressure operated valve configured to allow air to enter the pre-charge chamber when the pressure in the pumping chamber exceeds the pressure within the pre-charge chamber.

Preferably airflow into the or each pumping chamber is controlled by a pumping chamber inlet valve.

Preferably the or each pumping chamber inlet valve is a pressure operated valve configured to allow air to enter the pumping chamber when the ambient pressure surrounding the reciprocating engine exceeds the pressure within the pumping chamber.

Preferably the transfer of air from the or each pre-charge chamber to its associated combustion chamber is controlled by inlet ports or passages which are only open when its associated outer cylinder is at or near the end of its combustion or power stroke.

Preferably the inlet passages for each combustion chamber are a series of longitudinal slots situated about the circumference of the inner cylinder.

Preferably the transfer of exhaust gases out of the or each combustion chamber is controlled by exhaust ports or passages which are only open when its associated outer cylinder is at or near the end of its combustion or power stroke.

Preferably the exhaust ports for each combustion chamber are a series of holes situated about the circumference of its associated outer cylinder.

In a second aspect, the invention may broadly be said to consist in a vehicle or power generation machine incorporating at least one reciprocating engine substantially as specified herein.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

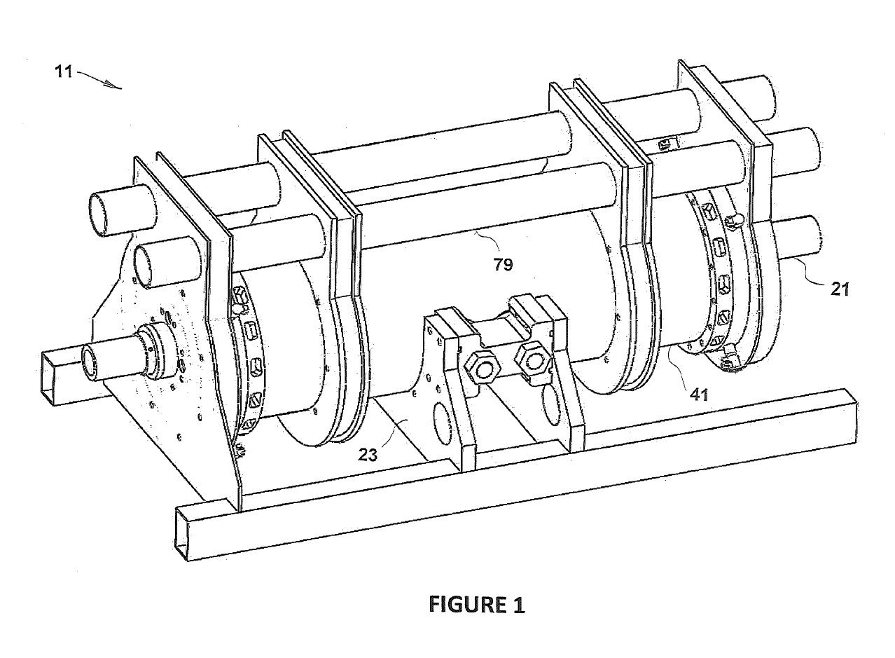

FIG. 1 is a perspective view of a first example of a reciprocating engine assembly according to the present invention,

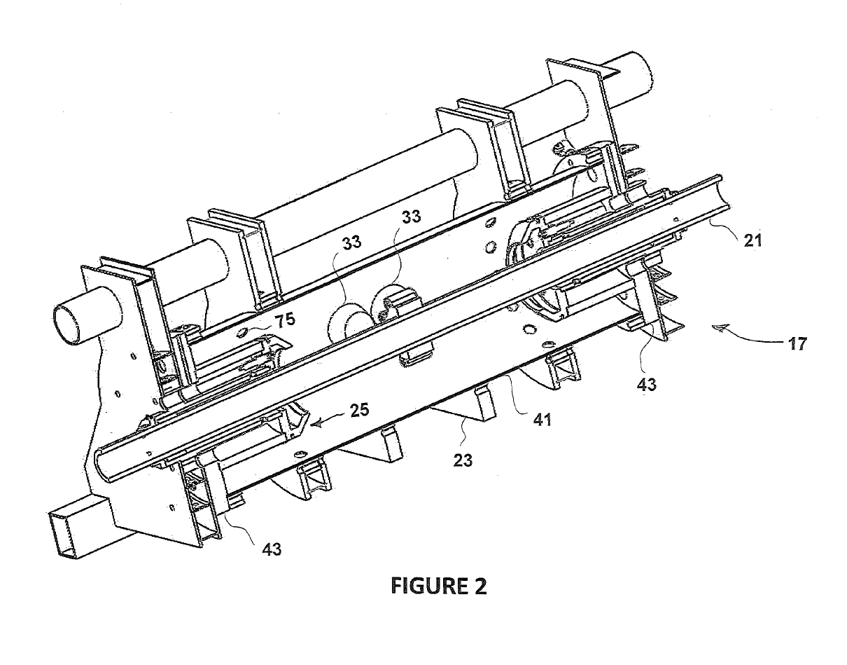

FIG. 2 is a cross sectional perspective view of the main fixed parts of the first example of a reciprocating engine and the output shaft,

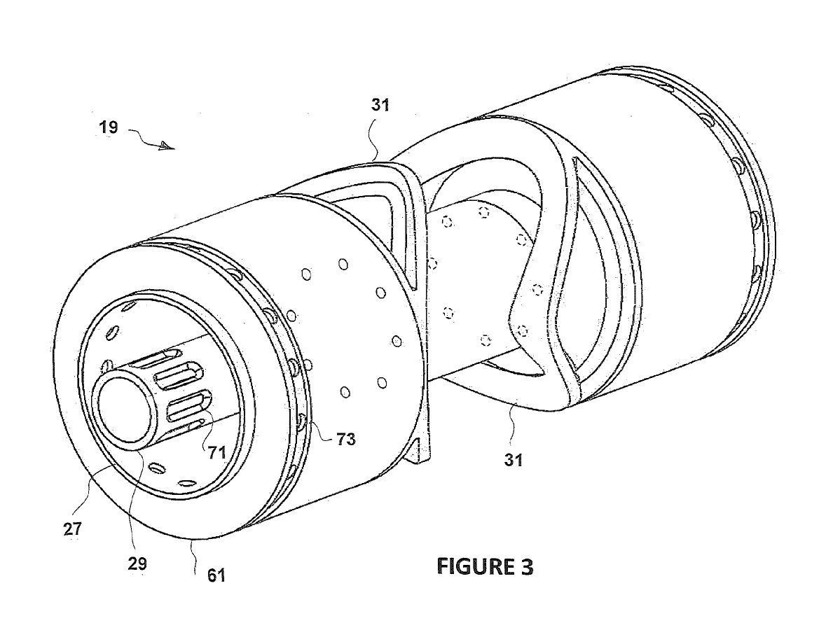

FIG. 3 is a perspective view of a rotating and reciprocating member of the first example of a reciprocating engine,

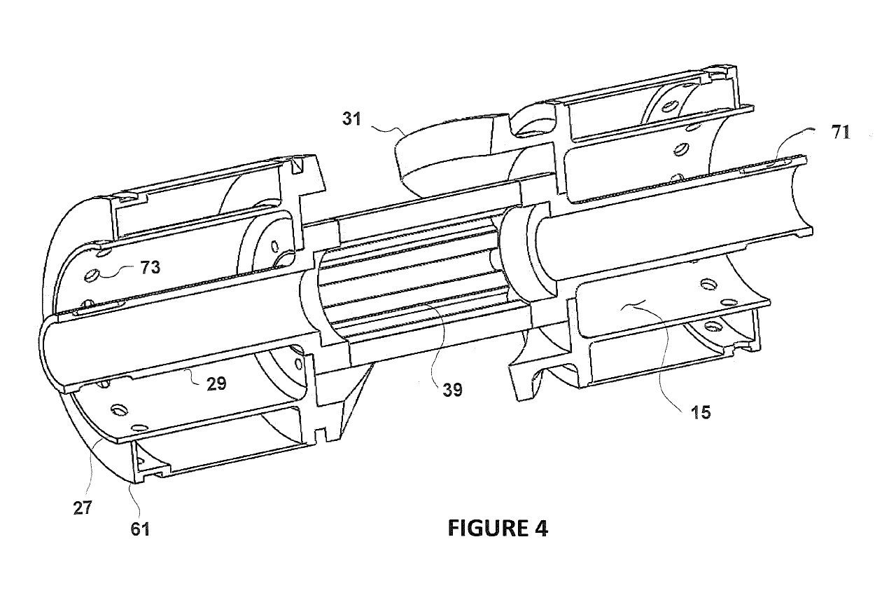

FIG. 4 is a cross sectional perspective view of the rotating and reciprocating member,

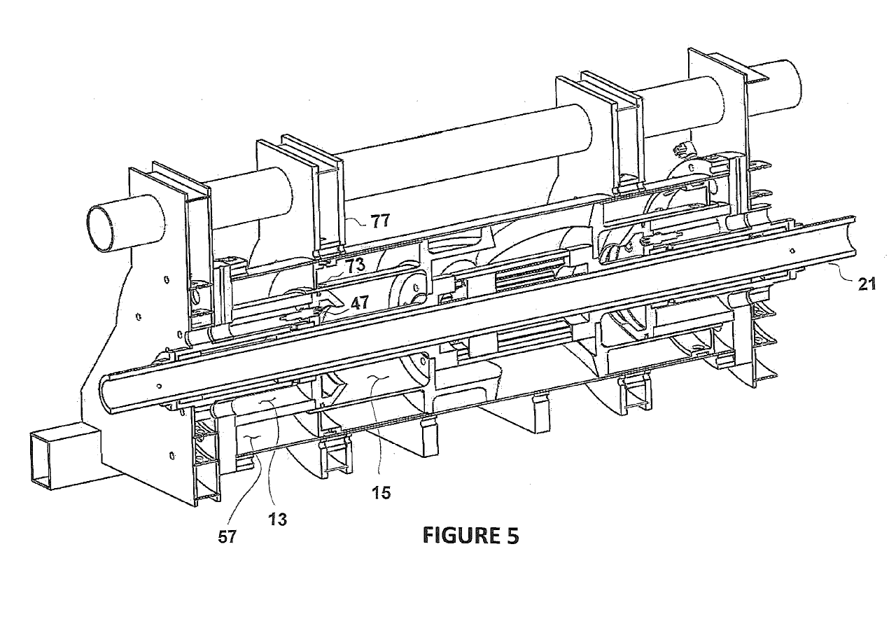

FIG. 5 is a cross sectional perspective view of the assembled reciprocating engine,

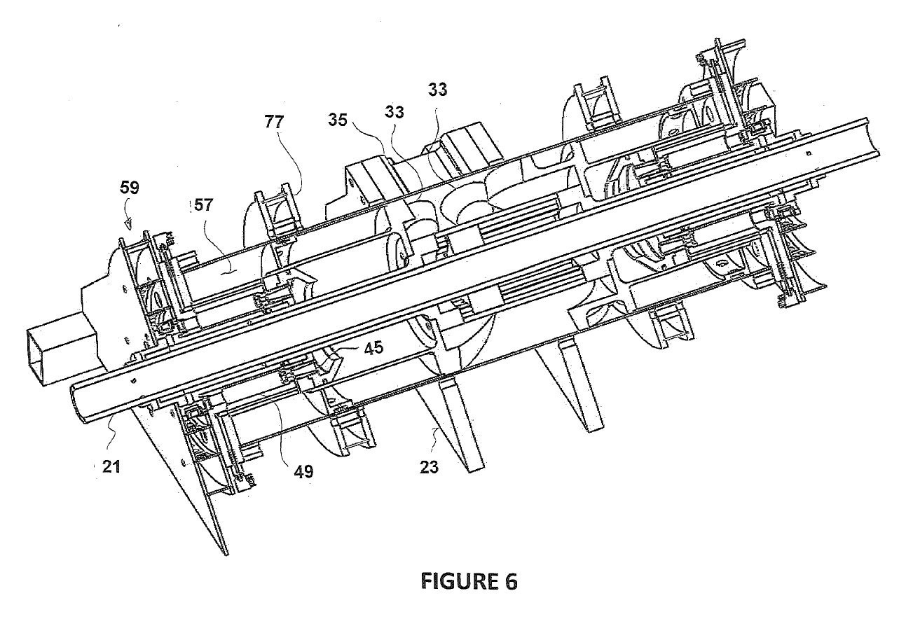

FIG. 6 is a second cross sectional perspective view of the assembled reciprocating engine,

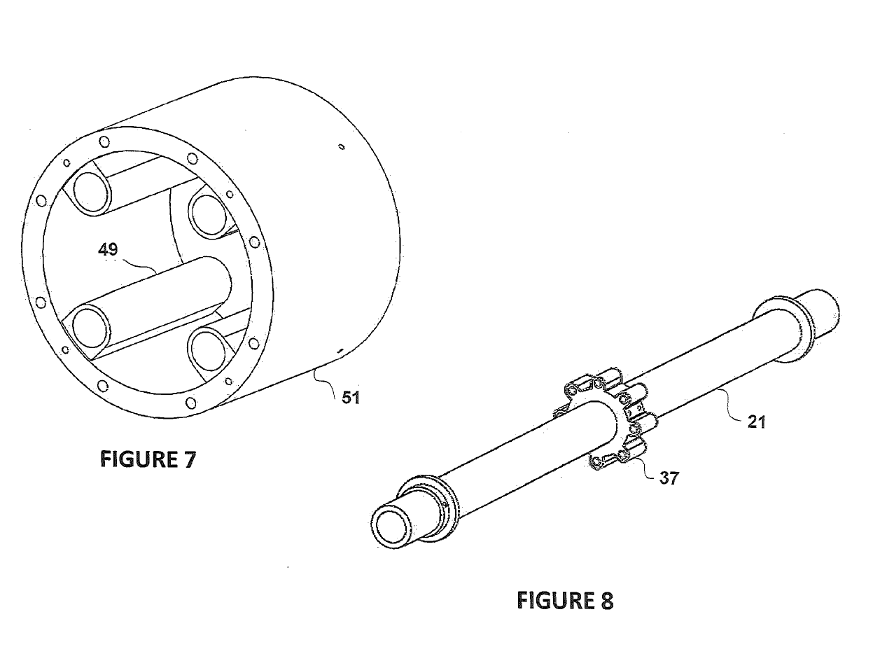

FIG. 7 is a perspective view of a cylindrical section of a fixed member of the reciprocating engine,

FIG. 8 is perspective view of the output shaft,

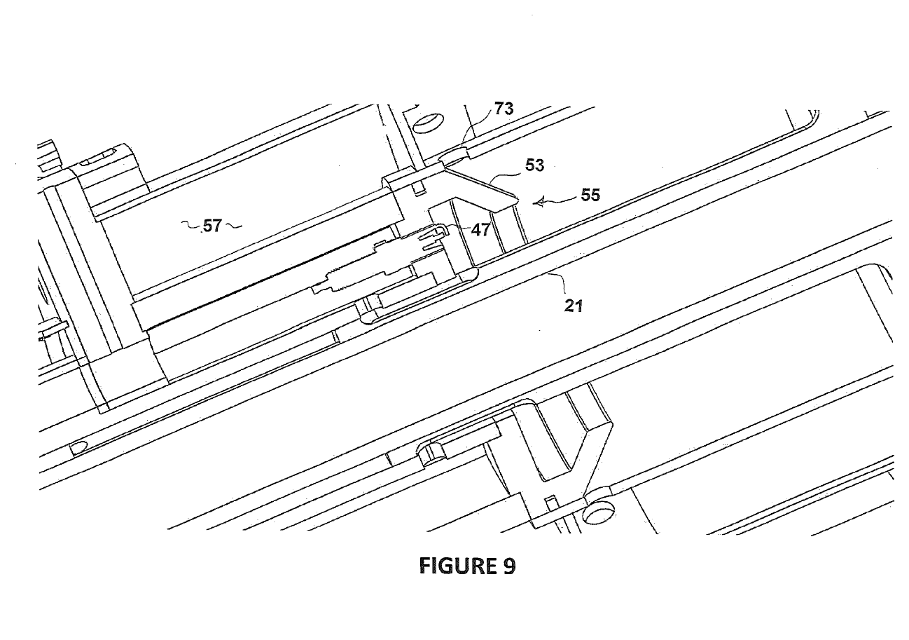

FIG. 9 is an enlarged cross sectional perspective view showing transfer ports between a pre-charge chamber and a combustion chamber,

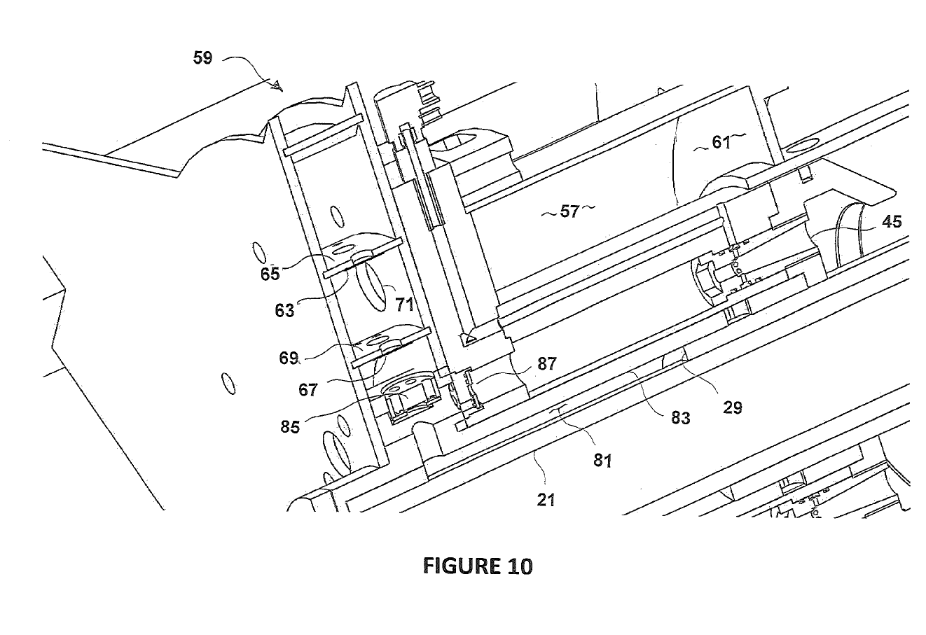

FIG. 10 is an enlarged cross sectional perspective view showing pumping chamber inlet ports and pre-charge chamber inlet ports,

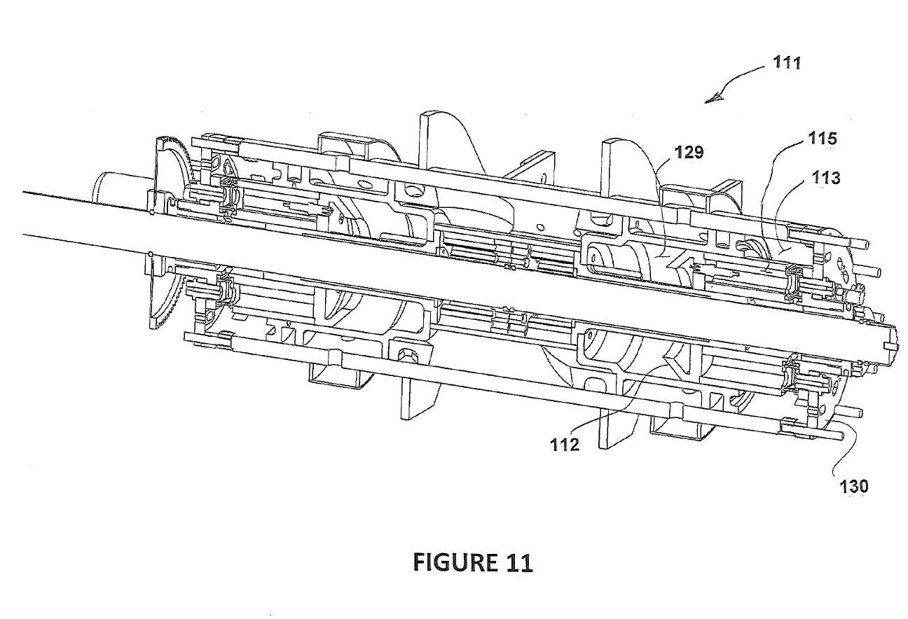

FIG. 11 is a cross sectional perspective view of a second example of a reciprocating engine assembly according to the present invention,

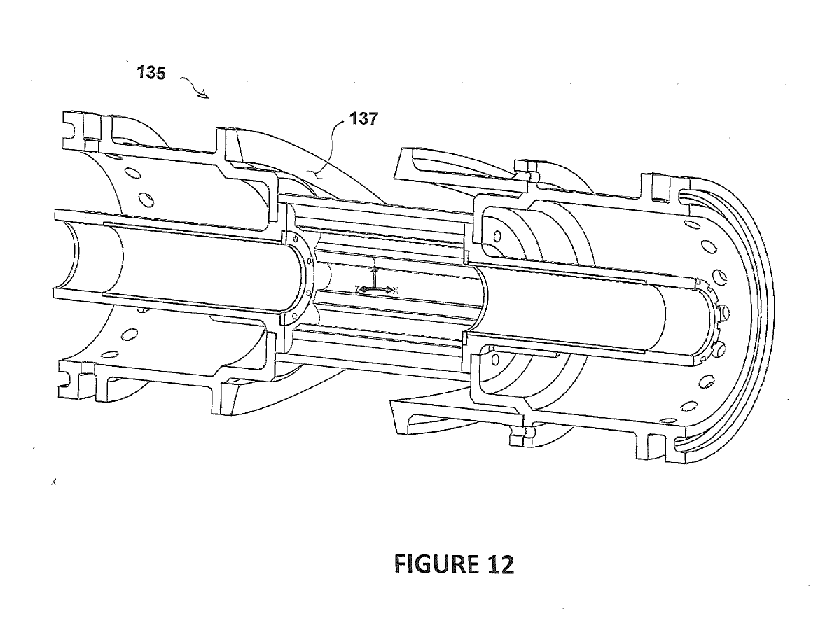

FIG. 12 is a cross sectional perspective view of the main rotating and reciprocating member of the second example of a reciprocating engine,

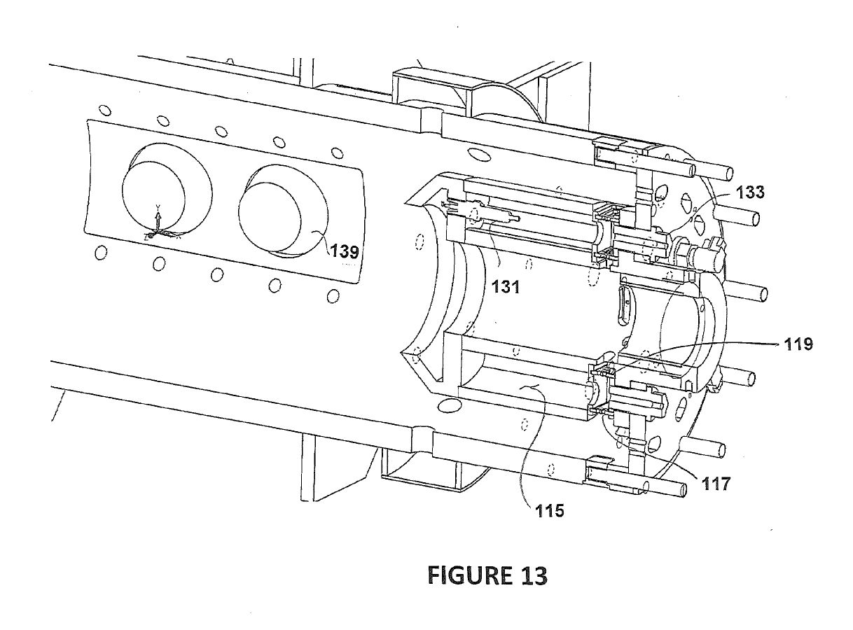

FIG. 13 is a cross sectional perspective view of the main fixed parts of the second example of a reciprocating engine,

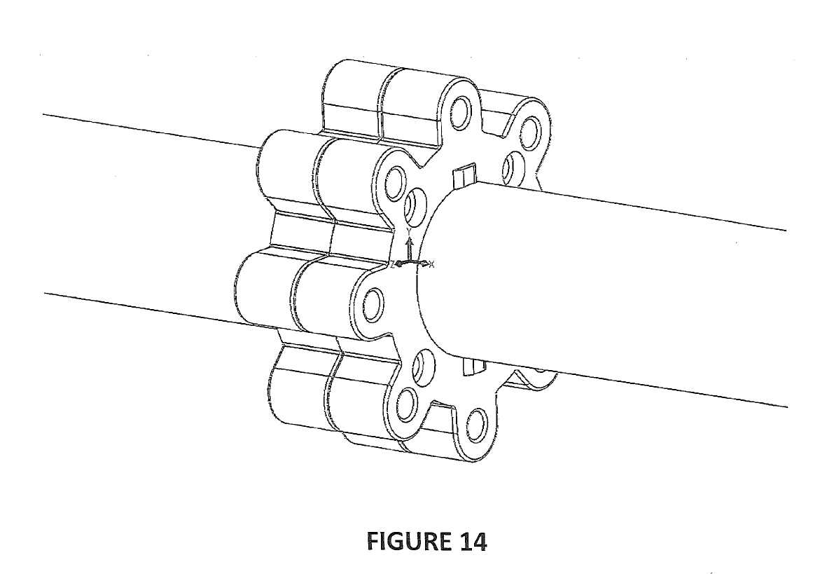

FIG. 14 is a perspective view of an output shaft of the second example of a reciprocating engine,

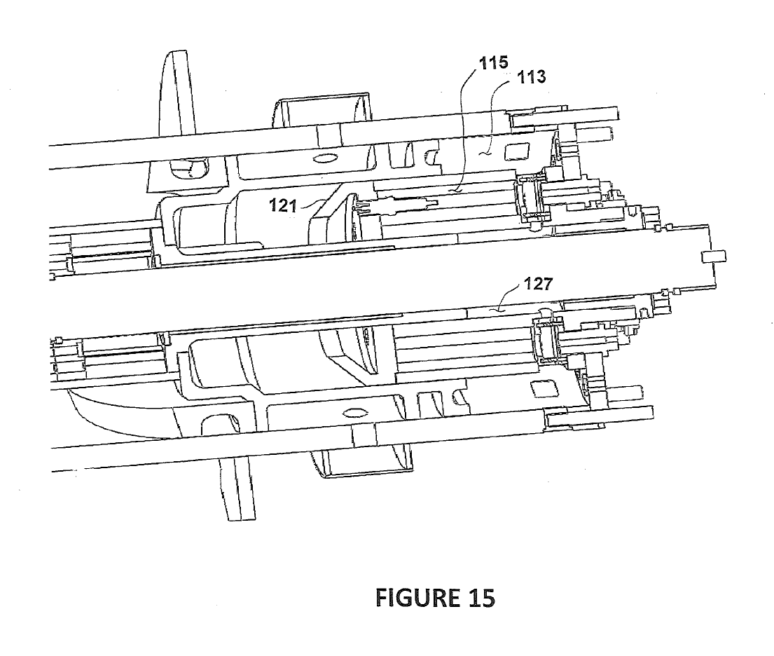

FIG. 15 is a cross sectional perspective view of the second example of a reciprocating engine in an assembled state showing ignition components, and

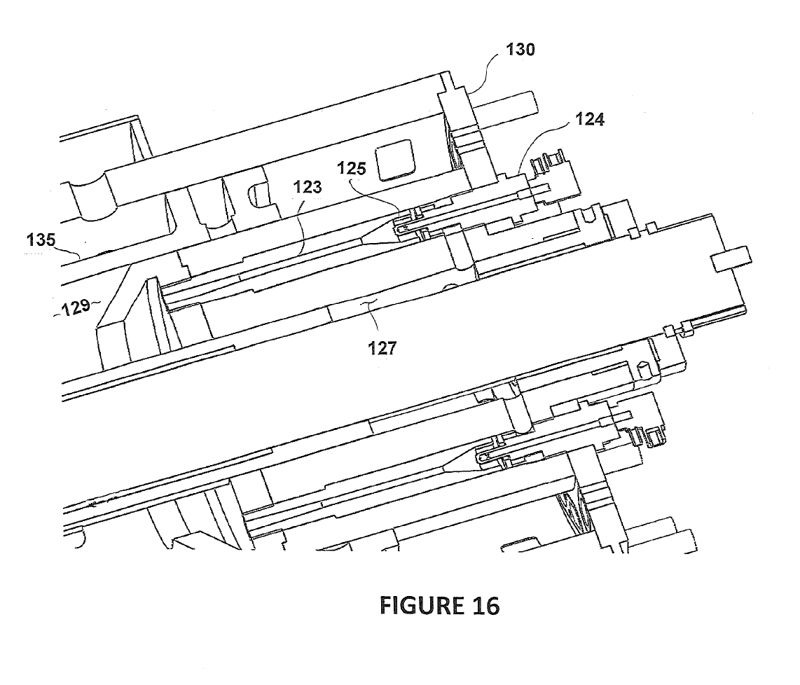

FIG. 16 is a cross sectional perspective view of the second example of a reciprocating engine in an assembled state showing components of the fuel system.

### FIRST EXAMPLE

The main components of a first example of a reciprocating engine (11) according to the present invention are shown in FIGS. 1 to 10. The reciprocating engine (11) is of the type having a reciprocating sleeve which reciprocates over a fixed piston or pistons, and is an internal combustion engine in which the combustion chamber breaths in a similar manner to a two stroke engine. The engine is crankshaft-less, and reciprocating motion is converted into rotary motion via an end cam and cam engagement roller arrangement.

As with other two stroke engines, the reciprocating engine (11) includes a pre-charge chamber (13) which supplies compressed air to each combustion chamber (15). However, as will be explained below, the operating sequence of the reciprocating engine (11) is quite different to conventional two stroke engines.

The reciprocating engine (11) is also distinguished by the feature of a fixed body (17), a rotating and reciprocating member (19) and an output shaft (21), that are all concentric to, and aligned with, a primary axis of the major components of the reciprocating engine (11). The fixed body (17) is fitted with engine mounts (23) to support the engine in a vehicle or a stationary situation. This arrangement provides a relative compact and light weight engine with a significant power to weight ratio.

In this example, the reciprocating engine (11) has two annular shaped combustion chambers (15). Each combustion chamber (15) is defined between a fixed member (25) connected to the fixed body (17) and the rotating and reciprocating member (19). Each fixed member (25) is in the form of a fixed piston member.

The rotating and reciprocating member (19) includes two outer cylinders (27) that are configured to engage with and reciprocate about their respective fixed members (25). Each combustion chamber (15) is an annular shaped chamber that is defined between its associated fixed member (25), outer cylinder (27) and an inner cylinder (29) of the rotating and reciprocating member (19). An inside diameter of the inner cylinder (29) fits over, and reciprocates relative to, the output shaft (21).

The rotating and reciprocating member (19) is coupled to the fixed body (17) in such a manner that reciprocating motion of the rotating and reciprocating member (19) produces rotation of the rotating and reciprocating member (19). In this example, this is achieved by coupling the rotating and reciprocating member (19) to the fixed body (17) via two opposed cylindrical end cams (31) which are each mated with a cam engagement roller (33). The two opposed cylindrical end cams (31) are integral parts of the rotating and reciprocating member (19). Each cam engagement roller (33) is supported by the fixed body (17) of the reciprocating engine.

The cam engagement rollers (33) are connected to the fixed body (17) of the reciprocating engine via roller support blocks (35). Each roller support block (35) includes two stub axles about which the individual cam engagement rollers (33) are mounted. The rollers (33) include needle roller bearings to provide minimal rolling resistance while experiencing the thrust loads from the rotating and reciprocating member (19) during its respective combustion strokes. It can be seen in FIG. 6 that the rollers (33) are tapered, with the apex of the taper of each roller (33) coinciding with the principal axis of the output shaft (21).

The rotating and reciprocating member (19) is coupled to the output shaft (21) in such a manner that only the rotational motion of the rotating and reciprocating member (19) is transferred to the output shaft. This is achieved by coupling the rotating and reciprocating member (19) to the output shaft (21) via a splined joint. The splined joint includes a male spline profile (37) on the output shaft (21) and a female spline profile (39) on the rotating and reciprocating member (19).

This arrangement means that when the reciprocating engine (11) is running, and the rotating and reciprocating member (19) is rotating and reciprocating, only the rotational motion of the rotating and reciprocating member (19) is transferred to the output shaft (21).

With reference to FIG. 2 it can be seen that the fixed body (17) consists primarily of an outer cylindrical sleeve (41) and an end cap (43) at each end of the cylindrical sleeve (41). The fixed pistons (25) are connected at their bases to the end caps (43).

The fixed pistons (25) include provisions to mount fuel nozzles (45) and/or fuel igniters (47). With reference to FIGS. 6 and 10 a fuel nozzle (45) is shown fitted into provisions in the crown of the fixed piston (25). The fuel nozzles (45) are situated within longitudinal tubes (49) which form part of a piston skirt (51) of each fixed member or fixed piston (25). The operation of the fuel injection system is explained below.

It can be seen also that a shroud (53) is connected to the circumference of a crown (55) of each fixed piston (25), and the shroud (53) is angled or tapered toward the principal axis of the fixed piston (25). The shroud (53) is designed to direct any incoming air and fuel mixture along the outer surface of the inner cylinder (29) for efficient scavenging of the combustion chamber (15) at the end of each combustion stroke.

In this example, the reciprocating engine (11) includes two pre-charge chambers (13), and each pre-charge chamber (13) communicates with an associated combustion chamber (15). Each pre-charge chamber (13) is situated within the piston skirt (51) of its associated fixed piston (25). Each pre-charge chamber (13) is an annular shaped chamber defined between its associated piston skirt (51), end cap (43), piston crown (55) and the outer surface of the inner cylinder (29).

The reciprocating engine (11) also includes two pumping chambers (57). Each pumping chamber (57) draws in air from an air inlet system (59) which includes an air filter, and supplies the pumped air to an associated pre-charge chamber (13). Each pumping chamber (57) is an annular shaped chamber situated about its associated fixed piston (25). Each pumping chamber (57) is defined between an inside surface of the outer cylindrical sleeve (41), an inner surface of one of the end caps (43), and outer surface of an associated piston skirt (51), and a plunger (61).

A pumping action within each pumping chamber (57) is provided by the plunger (61) which is coupled to the rotating and reciprocating member (19) associated with the fixed piston (25). Each time the rotating and reciprocating member (19) moves through a complete cycle, the plunger (61) also moves through a complete pumping cycle within the pumping chamber (57).

Fresh air is initially drawn from outside the engine and into the pumping chambers (57) via the air inlet system (59). Airflow into the pumping chambers (57) is controlled by an arrangement of pumping chamber inlet valves (63), which in this case is provided by a series of reed valves situated on the inside face of a first air inlet cylinder (65) situated in the air inlet system (59).

Each pumping chamber inlet valve (63) is a pressure operated valve configured to allow air to enter the pumping chamber (57) when the ambient pressure surrounding the reciprocating engine (11) exceeds the pressure within the pumping chamber (57).

The passage of air from each pumping chamber (57) to its associated pre-charge chamber (13) is controlled by a pre-charge inlet valve (67) arrangement situated about the internal circumference of a second air inlet cylinder (69) which is concentric to, and inside, the first air inlet cylinder (65). Each pre-charge inlet valve (53) is a pressure operated valve, for example a reed valve, configured to allow air to enter the pre-charge chamber (13) when the pressure in the pumping chamber (47) exceeds the pressure within the pre-charge chamber (13).

With reference to FIG. 9 it can be seen that the transfer of air from each of the pre-charge chambers (13) to its associated combustion chamber (15) is controlled by inlet ports or passages (71). The inlet passages (71) for each combustion chamber (15) are a series of longitudinal slots situated about the circumference of the inner cylinder (29). The inlet passages (71) are situated on the inner cylinder (29) in such a location that the inlet passages (71) only provide an open pathway for air to transfer from the pre-charge chambers (13) to their respective combustion chambers (15) when the associated outer cylinder (27) is at or near the end of its combustion or power stroke.

The transfer of exhaust gases out of the combustion chambers (15) is controlled by exhaust ports (73). The exhaust ports (73) for each combustion chamber (15) are a series of holes situated about the circumference of each outer cylinder (27).

The exhaust ports (73) of each combustion chamber (15) are only open when the associated outer cylinder (27) is at or near the end of its combustion or power stroke. At all other times the exhaust ports (73) surround the piston skirt (51) and do not provide an open exit for exit gases to exit the combustion chamber (15).

The exhaust ports (73) align with exhaust passages (59) within the plunger (61). And at the same time that the exhaust ports (73) clear the piston skirt (51) and become open, they also align with secondary exhaust ports (75) in the outer cylindrical sleeve (41). An exhaust manifold (77) surrounds the secondary exhaust ports (75) and collects the exhaust gases and directs them to an exhaust pipe (79).

A narrow air blast pumping chamber (81) can also be seen in FIG. 10. The air blast pumping chamber (81) is defined between the outer circumference of the output shaft (21) and the inside diameter of an air blast pumping chamber skirt (83) situated within the pre-charge chamber (13). Air is drawn into the air blast pumping chamber (81) from the pre-charge chamber (13) via a pressure operated air blast inlet valve (85). During the compression stroke, the free end of the inner cylinder (29) acts as a piston as it moves into the air blast pumping chamber (81) and compresses the air within the chamber (81).

This chamber (81) communicates with the longitudinal tubes (49) noted above. Air travels from the air blast pumping chamber (81) and into the longitudinal tubes (49) via a pressure operated air blast outlet valve (87). The blast of air then travels through the fuel nozzles (45) and into the combustion chamber (15). Fuel supplied to the fuel nozzles (45) by a fuel management system is picked up by the blast of air from the air blast pumping chamber (81) and is atomised and transported to the combustion chamber (15) via the fuel nozzles (45).

With reference to FIGS. 4 and 5, the operating sequence of this twin cylinder reciprocating engine (11) is now described as follows;
As the left hand outer cylinder (27) is moving through its power stroke (i.e. toward the position shown in FIG. 5), its associated plunger (61) is moving away from the pumping chamber inlet valves (63) and is drawing air from the atmosphere into the pumping chamber (57).
Then as the right hand cylinder (27) moves through its power stroke, the left plunger (61) is compressing air within the left pumping chamber (57). During this same stroke the air pressure within the left pumping chamber (57) will become greater than the pressure within the left pre-charge chamber (13) and compressed air will fill the left pre-charge chamber (13).
Then, the left hand cylinder (27) will move through its power stroke again, and when it is at the end of its power stroke the inlet passages (71) will become open and the compressed air within the left pre-charge chamber (13) will enter and purge the left combustion chamber (15) since the left cylinder exhaust ports (73) will also be open.
Then the left hand cylinder (27) moves through a compression stroke again, prior to fuel injection, and spark ignition at the start of the next power stroke.

It could be said that each intake of air passes through a six stage process which takes place during five strokes of the associated cylinder;
1. air is drawn into pumping chamber during a first power stroke,
2. the same air is compressed in the pumping chamber and passes into the pre-charge chamber during a first compression stroke,
3. the air then sits idle in the pre-charge chamber during a second power stroke,
4. then at the end of the second power stroke and at the beginning of a second compression stroke the air is transferred into the combustion chamber, and as it enters the combustion chamber it displaces the exhaust gases from the previous combustion event.
5. then the fresh charge of air is compressed within the combustion chamber during the second compression stroke, and
6. then during a third power stroke the air that was drawn into the pumping chamber during the first power stroke is used in combustion and is purged out of the combustion chamber at the end of the third power stroke.

Or alternatively, it could be said that air moving through the engine undergoes five distinct phases which take place during five strokes of the associated reciprocating cylinder;
1. Intake—air is drawn into the pumping chamber during the first stroke, which is part of the first combustion event.
2. Compress—the same air is compressed in the pumping chamber and passes into the pre-charge chamber during the second stroke, which is part of the first compression event.
3. Purge—air is transferred into the combustion chamber from the pre-charge chamber thereby displacing exhaust gases out the exhaust ports, at the end of the third stroke, which is part of the second combustion event.
4. Prepare—air is then mixed with fuel and compressed into a combustible mixture in the combustion chamber during the fourth stroke, which is part of the second compression event.
5. Combust—a spark ignites the air/fuel mixture creating gaseous expansion and cylinder pressure. This forms the power source behind the fifth stroke, which is part of the third combustion event.

This is sometimes referred to as the ‘Shepherd Two Stroke Combustion Cycle’.

It is envisaged that the reciprocating engine (11) could be used in a range of vehicles, or in power generation equipment, or in other stationary engine applications.

Ideally the end cam profile is as close as possible to forty five degrees to the principal axis of the engine for as much of the profile as possible. This allows for a one to one transfer of force from the reciprocating cylinders into torque in the output shaft, for as much of the stroke of each reciprocating cylinder as possible. In this way it is envisaged that much greater efficiencies will be achieved that with convention crankshaft engines which operate at inefficient crank angles for the greater part of each crank revolution.

### SECOND EXAMPLE

A second example of a reciprocating engine (111) according to the present invention is shown in FIGS. 11 to 16. The reciprocating engine (111) is similar to the first example of a reciprocating engine (11) except as noted in the following description.

The structure of the reciprocating engine (111) has been simplified to some extent, eliminating the need for multiple end bulkheads at each end of the engine as used in the first example. The valves which control the flow of air from a pumping chamber (113) to a pre-charge chamber (115), that is, the pumping chamber outlet valves (117) and the pre-charge outlet valves (119), are now situated within the base of the fixed piston (121).

As in the first example, the pumping chamber outlet valves (117) and the pre-charge outlet valves (119) control the movement of compressed air into and out of the pre-charge chamber (115) which is made up of a number of individual chambers situated within the fixed piston (121) walls. In this example, each pre-charge chamber (115) is substantially kidney shaped when viewed from either end of the engine, and the pre-charge chambers (115) extend axially within the fixed piston (121).

The new configuration of the second example of a reciprocating engine (111) provides a simplified fuel metering configuration from the point of view of manufacture, assembly and maintenance. The fuel components relating to the introduction of the fuel into the combustion chambers (129), are now installed through the single bulkheads (130) at each end of the engine.

A spark plug (131) is situated within one of the pre-charge chambers (115) and extends through to the combustion chamber (129). Access to the spark plug (131) is gained by removing a blanking plug (133), and installing a socket wrench between the valves (117) and (119), and through to the spark plug (131).

The fuel metering system includes a series of relatively narrow blast tubes (123) equally spaced about the annular shaped fixed piston (121). It is envisaged that a bead or droplet of fuel, or a small quantity of gaseous fuel, will be introduced by a fuel nozzle (124) to a receiving end (125) of each of the blast tubes (123), and then air from an air blast pumping chamber (127) will transport that fuel through the blast tubes (123) and into the combustion chamber (129). The fuel nozzles (124) are mounted in the bulkheads (130) at each end of the engine (111) allowing simplified access for maintenance purposes.

The reciprocating engine (111) is intended to operate in a highly fuel efficient manner. It is envisaged that the engine will run at relatively low speed compared to modern combustion engines, for example in the region of 500 to 1500 revolutions per minute as opposed to 3-6000 revolutions per minute.

Also, the operating pressures and temperatures will be much lower, and the noise and vibrations are expected to be very low. The pumping chamber (113) has been configured to pump air to about 25-30 psi in the pre-charge chambers (115). This pre-charge air is then transferred into the combustion chamber (129) at the end of the power stroke, to scavenge the combustion chamber (129), and then that air will be compressed to about 40-45 psi at the end of the compression stroke.

Towards the end of the compression stroke, air from the air blast pumping chamber (127), which is pumped to a pressure of around 100 psi, is able to pass from the air blast pumping chamber (127) and through the blast tubes (123) and into the combustion chamber (129). As noted above, fuel that has been deposited into the receiving end (125) of the blast tubes (123) is picked up by the blast of air and is carried into the combustion chamber (129). The timing of this blast of air will be dictated to some extent by the difference in pressure between the combustion chamber (129) and the air blast pumping chamber (127).

The pressure in the combustion chamber (129) will initially be higher than in the air blast pumping chamber (127), but as the reciprocating cylinder (135) moves toward the end of a combustion stroke in relation to one of the fixed pistons (121) the pressure within the associated air blast pumping chamber (127) increases to a pressure that exceeds the pressure within the combustion chamber (129) and air is then pumped from the air blast pumping chamber (127) and into the combustion chamber (129) via the blast tubes (123).

The fuel will be fully delivered to the combustion chamber (129) by about the end of the compression stroke. It is envisaged that the spark plug (131) will not be fired until the reciprocating cylinder (135) has moved to about the one o′clock position, using crank shaft engine terminology. It is envisaged that combustion will occur between the one o′clock and five o′clock positions. This relates to the time that the forty five degree slope on the end cams (137) is in contact with the cam engagement rollers (139).

During this time, the force exerted onto the reciprocating cylinder (135) by the expanding combustion gases is converted into torque by the end cams. In this way the efficiency of the engine is maximised, as power is extracted efficiently from the engine (111) during the entire combustion process. This compares to combustion occurring between eleven o′clock and five o′clock on conventional crankshaft engines, and only being converted efficiently into torque between two and four o′clock due to the known limitations of a conventional crank shaft, connecting rod and piston configuration.

With reference to FIG. 16 it can be seen that the path for the air from the air blast pumping chamber (127) is via the long and narrow air blast tubes (123). It is envisaged that not all of the air compressed within the air blast pumping chamber (127) will have time to enter the combustion chamber (129) before the power stroke begins and the volume in the air blast pumping chamber (127) begins to expand again. Initially the pressure remaining within the air blast pumping chamber (127) will help to move the reciprocating cylinder (135) in the direction of the power stroke, and then as the air pressure builds within the pre-charge chambers (115), a fresh supply of air will again flow from the pre-charge chambers (115) and into the air blast pumping chamber (127) to replenish the air blast pumping chamber (127).

Variations

Aspects of the present invention have been described by way of example only and it should be appreciated that modifications and additions may be made thereto without departing from the scope thereof.

The first example described above includes two combustion chambers (15) and associated components. A variation on this reciprocating engine could include a single combustion chamber and associated components, or it could include more than two combustion chambers and associated components.

In the first example described above, flow through the inlet passages (71) and the combustion chamber exhaust ports (73) is controlled by the relative position between the reciprocating cylinder (27) and the fixed piston (25). In an alternative configuration the inlet passages (71) and/or the combustion chamber exhaust ports (73) could be controlled by pressure operated valves or by mechanically operated valves.

In the first example described above, the engine (11) includes a cylindrical end cam (31) having two cam lobes. In an alternative configuration, the cylindrical end cam could include three or more cam lobes. Increasing the number of cam lobes allows for a shorter stroke and therefore a more compact engine assembly.

Definitions

Throughout this specification the word “comprise” and variations of that word, such as “comprises” and “comprising”, are not intended to exclude other additives, components, integers or steps.

Advantages

Thus it can be seen that at least the preferred form of the invention provides a reciprocating engine which is crankshaft-less and which converts reciprocating motion into rotary motion via and end cam and cam follower arrangement. This allows maximised torque to be gained from the engine throughout a wider range of each revolution of the engine.

The engine is also compact and has relatively few moving parts allowing for low cost of manufacture and high operational reliability.

The relatively large cross sectional area of the annular shaped combustion chamber gives the engine a relatively high swept volume compared to the overall size of the engine. The large area of the piston crown allows large forces to be generated by the engine and therefore relatively high torque can be produced, even at low operating speeds.

1-20. (canceled)

21. A reciprocating internal combustion engine having at least one cylinder, a drive shaft that is coaxial with the cylinder, and at least one reciprocating member configured to reciprocate and to cause the drive shaft to rotate, and the or each reciprocating member is connected to the driveshaft via a sliding joint that allows reciprocating motion of the reciprocating member in line with a longitudinal axis of the drive shaft whilst preventing rotational movement of the reciprocating member about or relative to the drive shaft.

22. A reciprocating internal combustion engine as claimed in claim 21, wherein the reciprocating motion of the or each reciprocating member is converted to rotary motion of the or each reciprocating member by an interaction between at least one end cam and at least one cam engagement roller.

23. A reciprocating internal combustion engine as claimed in claim 22, wherein the or each end cam or the or each cam engagement roller is fixed to a stationary part or frame of the engine.

24. A reciprocating internal combustion engine as claimed in claim 22, wherein the or each end cam is a part of the or each reciprocating member.

25. A reciprocating internal combustion engine as claimed in claim 22, wherein the or each end cam has a cam profile having two troughs and two peaks.

26. A reciprocating internal combustion engine as claimed in claim 25, wherein the or each end cam has a section which slopes at forty five degrees relative to a longitudinal axis of the driveshaft, between each peak and trough of the cam profile of the or each end cam.

27. A reciprocating internal combustion engine as claimed in claim 22, wherein the or each end cam has a sinusoidally curved profile.

28. A reciprocating internal combustion engine as claimed in claim 21, wherein the engine includes one or more combustion chambers, the or each combustion chamber being defined between the or each reciprocating member and at least one fixed member of the engine.

29. A reciprocating internal combustion engine as claimed in claim 21, wherein the or each reciprocating member is a double ended reciprocating member.

30. A reciprocating internal combustion engine as claimed in claim 29, wherein the engine has two double ended reciprocating members and is configured such that the two double ended reciprocating members always travel in opposite directions to one another.

31. A reciprocating internal combustion engine as claimed in claim 29, wherein the or each double ended reciprocating member defines a combustion chamber at both ends of the or each double ended reciprocating member.

32. A reciprocating internal combustion engine as claimed in claim 31, wherein the engine includes at least two double ended reciprocating members.

33. A reciprocating internal combustion engine as claimed in claim 21, wherein there is at least one inlet passage and at least one outlet passage in communication with the or each combustion chamber.

34. A reciprocating internal combustion engine as claimed in claim 33, wherein there is at least one valve controlling the flow of gases through the or each inlet and outlet passage.

35. A reciprocating internal combustion engine as claimed in claim 34, wherein the valves associated with each combustion chamber of a four combustion chamber version of the engine are configured to sequence the firing order of the combustion chambers.

36. A reciprocating internal combustion engine as claimed in claim 21, wherein the joint between the or each reciprocating member and the driveshaft is a splined joint, having clearance to facilitate reciprocating motion of the or each reciprocating member.

37. A reciprocating internal combustion engine as claimed in claim 36, wherein the or each reciprocating member has a female spline centred about its axis of rotation.

38. A reciprocating internal combustion engine as claimed in claim 37, wherein the driveshaft has one or more male spline features centred about its axis of rotation.

39. A reciprocating internal combustion engine as claimed in claim 21, wherein the engine includes at least one spark plug in communication with the or each combustion chamber.

40. A reciprocating internal combustion engine as claimed in claim 21, wherein the engine includes at least one fuel injector in communication with the or each combustion chamber.
